(19) United States
(12) Patent Application Publication
(10) Pub. No.: US 2004/0232796 A1
(43) Pub. Date: Nov. 25, 2004

(54) Electric synchronous machine comprising a toroidal winding

(76) Inventor: Leopold Weissensteiner, Korneuburg (AT)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/476,387

(22) PCT Filed: Apr. 30, 2002
(86) PCT No.: PCT/EP02/04770

(30) Foreign Application Priority Data
Apr. 30, 2001 (DE) 101 22 135.0
Nov. 12, 2001 (DE) 101 55 918.6

(51) Int. Cl. H02K 1/00; H02K 3/00

(52) U.S. Cl. 310/216; 310/179

(57) ABSTRACT

The fundamental construction of electrical machines with arrangement of coilings on pole shoes has not changed for decades. The machines have, depending on their utilization as generators or motors, a limited efficiency and/or a limited torque and a limited performance/mass ratio.

A design is being proposed where the stator and/or the rotor consists of a ring core (1) made of magnetically conducive material having areas acting as magnetic poles (4), recesses (2) in equal distribution or meander-shaped protruding and/or retreating areas (7) in radial direction, into which coil sections (3) of at least one coil are wound over an axis lying in the peripheral direction of stator and/or rotor and where the distances between the inversely poled permanent magnets (5) producing the exciting field or the electrically excited poles essentially correspond to the size of the interpolar gaps in stator and/or rotor. The machine has a substantially improved performance/mass ratio.

The invention concerns an electrical machine with permanent magnetic or electrical excitation which can be used as a motor and/or a generator. The machine can be operated by direct or alternating current.

Electrical machines usually have a rotor with at least one permanent magnet or an electrically excited pair of poles and a stator where the coils are wound on pole shoes or embedded in recesses of a bundle of laminations. If the rotor is provided with several permanent magnets, they are aligned alternatingly according to the number of poles.

In principle, the design of such machines has not changed for decades. The machines have, depending on their being used as generator or motor, a limited efficiency, or rather a limited torque and a limited performance/mass ratio.

The invention aims at designing an electrical machine of the aforementioned kind having a higher efficiency and/or torque than conventional machines and a significantly improved performance/mass ratio.

According to the invention, the task is solved by the characteristics according to claim 1. Suitable versions of the devices according to the invention are specified in sub-claims.

In accordance to that, the stator and/or rotor consists of a ring core made of magnetically conductive material having between the sections which act as magnetic poles, recesses in regular distribution or meander-shaped protruding or retreating sections in radial direction, where coil sections with at least one coil are wound around an axis lying in the peripheral direction of the stator and/or rotor.

The clearances between the oppositely poled put magnets which produce the exciter field, respectively between the poles in case of electrical excitation, essentially correspond to the dimension of the interpolar gaps in stator and/or rotor.

Preferably, a stator coil or a rotor coil is a multiple coiling, the individual coils of which can be opened with separate outlets or paralleled, an especially suitable version having an even number of coils. Thus the coilings consist of coil section alternating on the periphery of stator and/or rotor and connected in series, so that the oppositely poled coil sections are distributed over the periphery of the stator ad/or rotor.

In an especially preferred way, the multiple coiling consists of a stator coiling consisting of two coilings, separately wired to consumer devices with coil sections on the periphery of the stator in alternative sequence and connected in series.

It is of no consequence whether the rotor is cylinder shaped or disk shaped.

For example, the recesses for a stator coil may start from the inner periphery and/or in case of a disk shaped rotor from the inside of the stator. They may also start from the inside and the outside and form bridges for the coil sections between the stator poles, but then they have only a small magnetic cross-section opposite to the pole zone. It is better to maintain the magnetic cross-section uniform by giving the stator ring a meander-shaped design.

“Meander-shaped protruding” means in the present case that the sections which form the recesses of a stator coil are set back in radial direction in a machine with cylinder shaped rotor, and in a machine with disk shaped rotor in axial direction, pointing away from the air gap.

“Meander-shaped retreating” refers to a rotor where these sections are set back in an inverse way in direction to the rotor centre.

Stator and rotor, when equipped with coils, consist of a suitable, magnetically conductive material, e.g. soft iron or ferrite, or are sheet-iron, as usual.

The machine can be used as a generator and as a motor.

If a permanent-magnetically excited machine has several permanent magnets per magnetic pole in the rotor, or if e.g. horseshoe permanent magnets are used, the magnets are arranged in a way to produce a polarity corresponding to the stator poles, i.e. north-south, south-south etc. The permanent magnets can also occupy the over-all span of the pole; then the polarity is north-south, north-south etc.

An arrangement preferable for variing performances consists in operating several machines, designed in the aforementioned way, by a common driving or power take-off axis, so that merely the coils of individual stators can be circuited, if necessary. Also a mechanical separation can be designed whereby individual or all stators on the periphery or reaching through the stator are mounted on rails, so that they can be removed from their rotors.

The invention shall be explained in detail on the basis of a demonstration example. The respective drawings show:

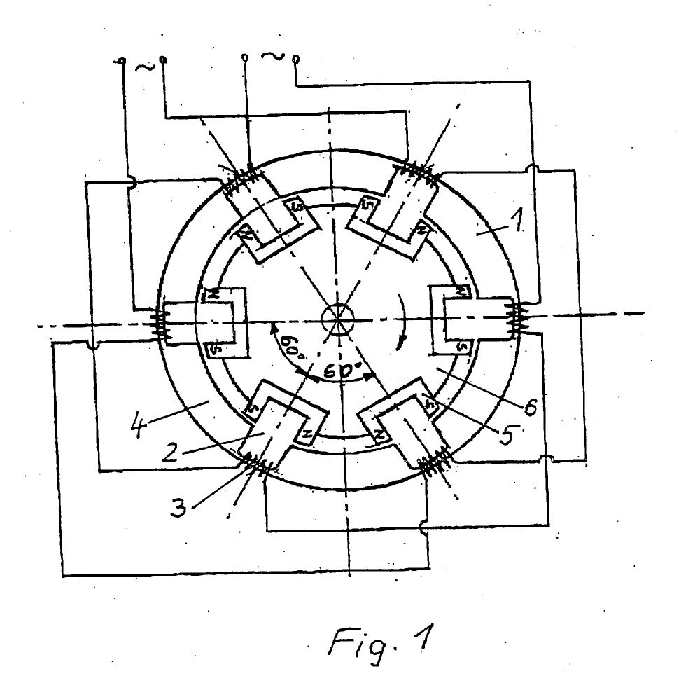

FIG. 1 cross-section of an electrical machine according to the present invention

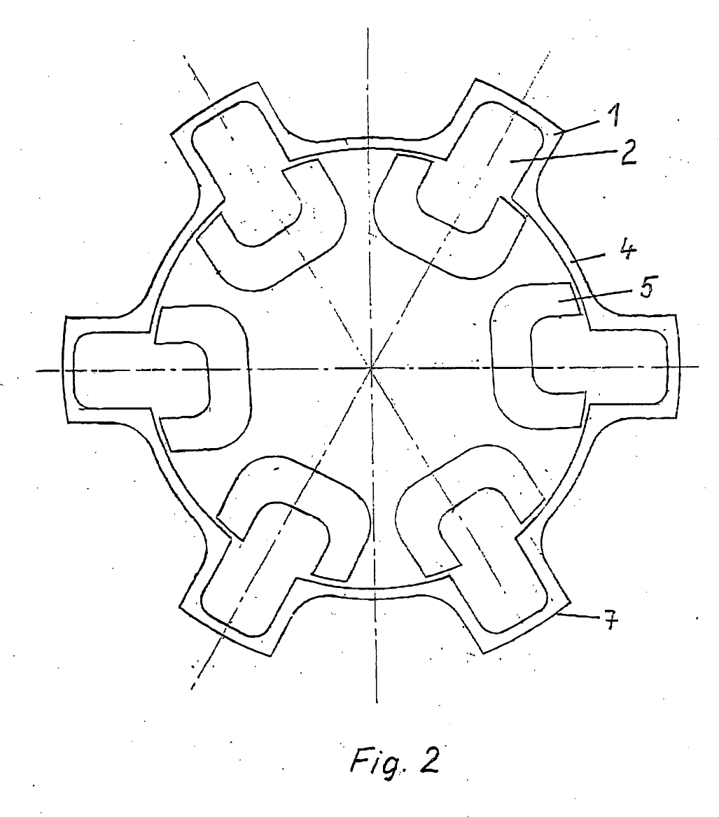

FIG. 2 a version of the machine with a special sheet-iron design

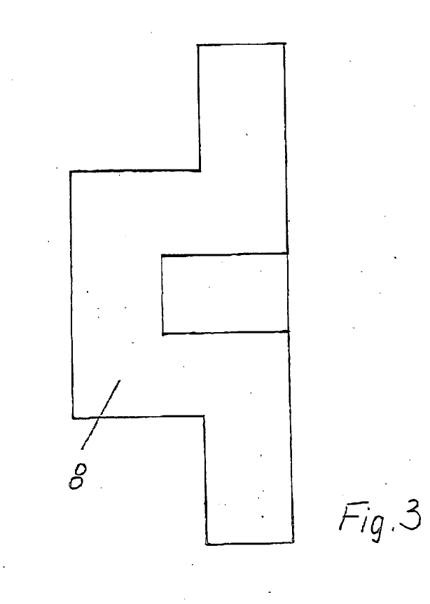

FIG. 3 plan view of a stator of a machine with disk-shaped rotor and

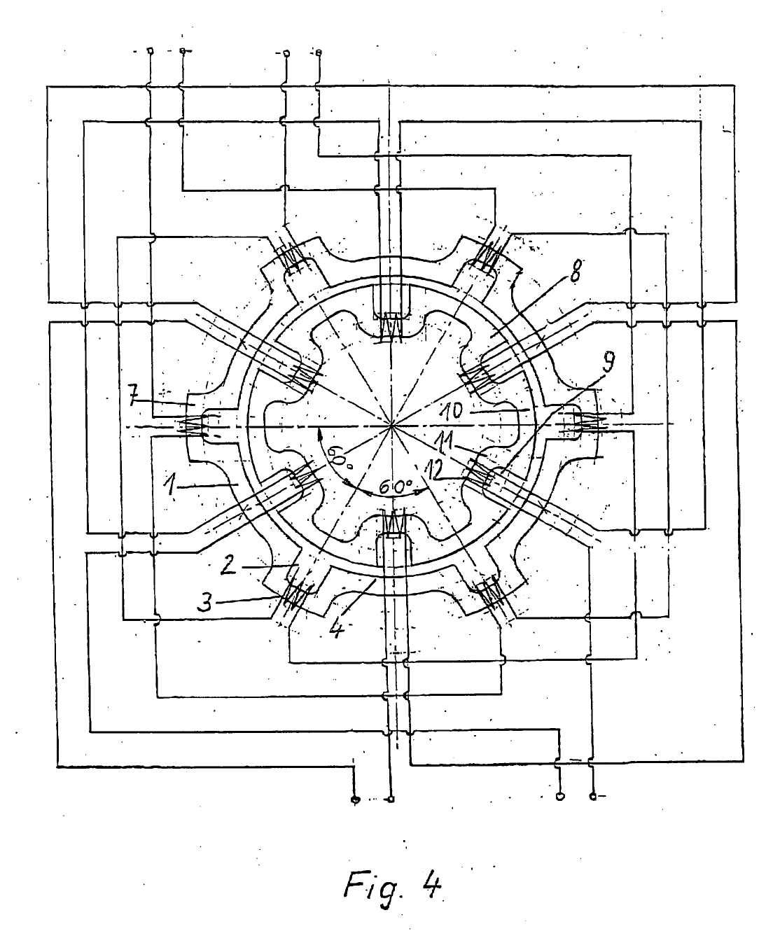

FIG. 4 a second version with a special sheet-iron design in stator and rotor.

FIG. 1 is a diagram of the cross-section of a generator according to the present invention. The stator consists of a stator ring 1, laminated in the usual way. Recesses 2 are evenly spaced on the periphery of the stator ring 1 where coil sections 3 of two coils are wound. The coil sections 3 are connected in a way that on the periphery of stator ring 1 the coil sections 3 of every coil are alternating and every three coil sections 3 are connected in series to one coiling. Between the recesses 2 are the respective magnetic stator poles 4. Both coilings can also be connected in an inverse parallel way, that is to say, the beginning of the first coil is connected to the end of the second coil and vice versa.

The rotor bears a permanent magnetic field which is outlined in FIG. 1 by horseshoe magnets 5. The horseshoe magnets 5 have a field direction which alternates over the periphery of the rotor, that is to say, north-south is followed by south-north etc. Rotor poles 6 with alternating field direction are placed between the permanent magnets. The interpolar gaps of horseshoe magnets 5 are formed in a way that poles of equal length in stator and rotor are situated opposite to one another. The horseshoe magnets 5 can be designed in a way that the distance between south-south and north-north becomes zero, so that, in the end, the arrangement north-south will result. Basic prerequisite is, however, that the distance of the magnet poles corresponds to the interpolar gaps and/or to the length of the coil sections 3. Other forms of magnets corresponding to these conditions can equally be used.

Interaction of coils can be demonstrated by short-circuiting the stator coils. In a conventional generator, a short circuit produces a braking action. In the case of the present generator, however, no braking action whatsoever takes place, as tests with a simple sample machine have shown. On the contrary, the drive power required falls beneath the idling power.

Moreover, the following effect can be proved: If both circuits are operated at the same time, but separately, that is to say, each one equipped with a separate consumer device, as shown in FIG. 1, then there flows not only double the amount of electricity, as would be expected, but there flows many times the amount in every circuit. Moreover, included voltage increases by mutual induction in the coils.

A further positive effect regarding efficiency shows when several generators are mounted on one driving axis and the coils of the first generator are individually connected in series to the individual coils of the second generator.

FIG. 2 shows one version with a stator ring 1, the cross-section of which is almost equal along the whole periphery, where stator poles 4 are tapered and the inner diameter remaining uniform, so that the coil-bearing parts of stator ring 2 are developed as meander-shaped protruding zones 7. Apart from the constant magnetically effective cross-section, saving of stator material is achieved, and thus the performance/mass ratio is further improved. Of course, designs are conceivable where the thickness of stator ring 2 in the magnetic pole area 4 lies between that of the two versions which herewith are given as mere examples.

FIG. 3 shows a stator according to the present invention on a machine with disk-shaped rotor. In the same way as in arrangement FIG. 2, the meander-shaped area 8, here in axial direction, are protruding.

FIG. 4 shows a version where stator and rotor are shaped according to the present invention as a coiled ring. The stator corresponds to version FIG. 2, the stator coiling to version FIG. 1. In the same way, the rotor consists of a rotor ring 8 with magnetic poles 10 which are excited by coil sections 12. The coil sections 12 are situated in recesses 9 of rotor ring 8 which are formed by radially retreating areas 11.

### List of Reference Symbols

1 stator ring

2 recess

3 coil area

4 magnetic pole

5 horseshoe magnet

6 rotor pole

7 (protruding) area, meander-shaped areas

8 rotor ring

9 recess

10 magnetic pole (of the rotor)

11 retreating zone

12 coil section

1. Electrical machine with permanent magnetic or electrical excitation, characterized by a stator and/or rotor consisting of a ring core (1) of magnetically conductive material having between the areas which act as magnetic poles (4) equally distributed recesses (2) or meander-shaped in radial direction protruding resp. retreating areas, into which coil sections (3) of at least one coil are wound over a coiling axis situated in direction of the stator and/or rotor periphery and where the distances between the inversely poled permanent magnets (5) producing the exciting field or electrically excited poles essentially correspond to the size of the opposite interpolar gaps in stator and/or rotor.

2. Electrical machine according to claim 1, characterized by the coiling being a multiple coiling.

3. Electrical machine according to claim 2, characterized by the multiple coiling consisting of an even number of coils with coil sections (3) alternating on the periphery of stator and/or rotor and connected in series.

4. Electrical machine according to claim 3, characterized by the coils being connected in an antiparallel way.

5. Electrical machine according to claim 3, characterized by the coils being connected separately to consumer devices.

6. Electrical machine according to claim 3, characterized by the multiple coiling consisting of two coilings connected separately with consumer devices with coil sections on the periphery of stator and/or rotor in alternative sequence and connected in series.

7. Electrical machine according to claim 1, characterized by recesses (2) which, in case of a machine with cylinder-shaped rotor, start from the inner periphery of the stator and/or the outer periphery of the rotor.

8. Electrical machine according to claim 1, characterized by recesses (2) which, in case of a cylinder-shaped rotor, start from the inner and outer periphery of stator and/or rotor.

9. Electrical machine according to claim 1, characterized by recesses (2) which, in case of a machine with disk-shaped rotor, start from the inside of stator and/or rotor.

10. Electrical machine according to claim 1, characterized by recesses (2) which, in case of a machine with disk-shaped rotor, start from the inner and outer side of stator and/or rotor.

11. Electrical machine according to claim 1, characterized by stator and/or rotor consisting of soft iron.

12. Electrical machine according to claim 1, characterized by stator and/or rotor consisting of ferrite.

13. Electrical machine according to claim 1, characterized by stator and/or rotor being sheet-iron.

14. Electrical machine according to claim 1, characterized by the magnetic polarity of permanent magnets (5) in rotor alternating north-north and south-south.

15. Electrical machine according to claim 1, characterized by the magnetic polarity of permanent magnets (5) in the rotor being alternatively north-south.

16. Electrical machine according to claim 1, characterized by several of their kind being placed one after another on a driving shaft and/or power take-off shaft.

17. Electrical machine according to claim 16, characterized by stators of the machines being placed on rails and removable from their rotors.
